(19) United States
(12) Patent Application Publication
(10) Pub. No.: US 2017/0247983 A1
(43) Pub. Date: Aug. 31, 2017

(54) METHODS FOR MITIGATING ANNULAR PRESSURE BUILDUP IN A WELLBORE USING MATERIALS HAVING A NEGATIVE COEFFICIENT OF THERMAL EXPANSION

(71) Applicant: Halliburton Energy Services, Inc., Houston, TX (US)

(72) Inventors: Gary P. FUNKHOUSER, Roman Forest, TX (US); Samuel J. LEWIS, Spring, TX (US)

(21) Appl. No.: 15/513,978

(22) PCT Filed: Oct. 16, 2014
(86) PCT No.: PCT/US2014/060796

§ 371 Date: Mar. 23, 2017

(51) Int. Cl. E21B 41/00; C09K 8/03; C09K 8/40; E21B 36/00; E21B 33/13

(52) U.S. Cl. CPC E21B 41/00; E21B 36/00; E21B 33/13; C09K 8/40; C09K 8/032; C09K 2208/10

(57) ABSTRACT

Pressure buildup can be extremely problematic during subterranean operations when there is no effective way to vent or otherwise access one or more sealed annuli within a wellbore. This condition can compromise casing integrity and ultimately lead to failure of a well. Methods for mitigating annular pressure buildup can comprise: providing a wellbore containing an annular space having one or more annuli therein; selecting a pressure-mitigating material based upon one or more conditions present within the annular space, the pressure-mitigating material having a negative coefficient of thermal expansion; introducing the pressure-mitigating material into the annular space of the wellbore; sealing at least a portion of the annular space after introducing the pressure-mitigating material thereto; and subjecting the pressure-mitigating material to a temperature increase in the sealed portion of the annular space to decrease a volume occupied therein by the pressure-mitigating material.

### BACKGROUND

The present disclosure generally relates to subterranean operations conducted within a wellbore, and, more specifically, to methods for mitigating the effects of annular pressure buildup in a wellbore.

After drilling a wellbore, a casing is often inserted into the wellbore to, inter alia, stabilize the walls of the wellbore and to control fluid flow within the wellbore. In many instances, a series of casings may be disposed concentrically within the wellbore, with the largest diameter casing being located nearest the upper terminus of the wellbore and the successive casings decreasing progressively in size. The separation between the casings defines an annular space containing one or more annuli.

FIG. 1 shows an illustrative schematic of a wellbore having multiple annuli present therein. As shown in FIG. 1, wellbore 1 penetrates subterranean formation 2. Within wellbore 1, concentrically placed casing pipes define annuli 3A-3D. While shown with four concentric annuli, depending on the length of wellbore 1, any number concentric annuli may be present. Annulus 3A, which is defined between the innermost casing surface and production tubing 5, extends through the entirety of wellbore 1 and maintains fluid communication with the upper terminus of wellbore 1. Although FIG. 1 has depicted wellbore 1 as having a substantially horizontal section and a substantially vertical section, it is to be recognized that any wellbore orientation may be present.

In the process of drilling and servicing wellbore 1, a drilling fluid or a treatment fluid can become disposed within annuli 3B-3D. The annular fluid can eventually lead to pressure buildup, as discussed below.

In traditional cementing with concentric casing pipes, cement is introduced through the innermost (at the time) casing pipe and upwardly displaces into the annulus defined between the newly placed casing pipe and the previously placed one. In reverse circulation cementing operations, cementing fluids are placed down through the annulus and into the bottom of the casing. In either case, the goal is for the cement to completely fill the annular space at the bottom of the annulus. The selected process (traditional or reverse) continues as additional casing pipes are set in place while further extending wellbore 1. The incursion of cement into annuli 3B-3D results in the formation of sealing cement plugs 4B-4D at their lower termini, thereby preventing the annular fluid from moving through the lower termini.

Annuli 3B-3D are often sealed at their upper termini as well, thereby trapping the annular fluid within a confined space. When annuli 3B-3D are sealed at both their upper and lower termini, a pressure increase can occur upon the trapped annular fluid undergoing thermal expansion due to exposure to high-temperature produced fluids. An increase in pressure in a sealed annular space will be referred to herein as “annular pressure buildup.” Other terms commonly used to describe this occurrence include “trapped annular pressure” and “annular fluid expansion.”

Annular pressure buildup can lead to a number of undesirable effects within a wellbore, including casing integrity issues and ultimately well failure. In land-based wells, there is usually ready access to each annulus within a multi-annular wellbore. This can allow venting of annular pressure to take place before casing damage occurs. Subsea wells, in contrast, commonly provide ready access only to the innermost annulus, and it is difficult, if not impossible, to provide pressure relief to the outer annuli containing trapped annular fluid. In addition, cold sea bottom temperatures coupled with high produced fluid temperatures can produce a large temperature differential in the trapped annular fluid. Since volume expansion increases linearly with the temperature differential, subsea wellbores can be particularly prone to large pressure increases within the sealed annuli.

A number of solutions have been proposed or implemented to address annular pressure buildup. Pressure-collapsible materials such as hollow spheres and syntactic foam, for example, can mitigate annular pressure buildup by providing an increase in effective fluid volume upon their collapse. Such materials are limited, however, in that they are only effective for one pressurization cycle. That is, once they have collapsed in response to a pressure increase, they are no longer viable to further decrease the pressure. Additionally, the pressure for initiating their collapse may be above a threshold pressure at which casing damage begins to occur. Other approaches for mitigating annular pressure buildup include cementing the entire annular space, insulating the casing to minimize heat transfer, using high strength casing, and installing pressure relief valves in communication with the sealed annuli. These solutions, however, can often be complicated to implement, particularly in a subsea wellbore, and can dramatically increase drilling and production costs.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, as will occur to one having ordinary skill in the art and the benefit of this disclosure.

FIG. 1 shows an illustrative schematic of a wellbore having multiple annuli present therein.

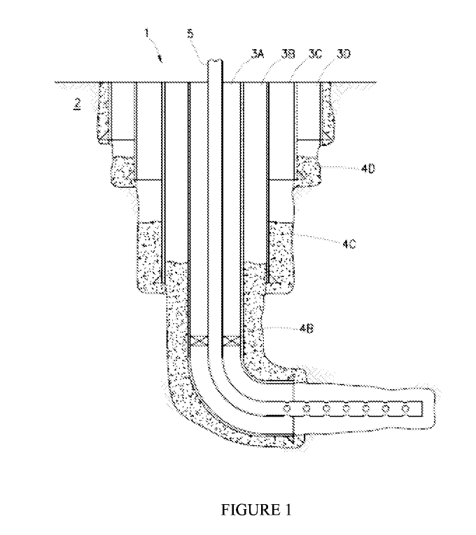

FIG. 2 shows an illustrative schematic of a system that can deliver treatment fluids of the present disclosure to a downhole location, according to one or more embodiments.

### DETAILED DESCRIPTION

The present disclosure generally relates to subterranean operations conducted within a wellbore, and, more specifically, to methods for mitigating the effects of annular pressure buildup in a wellbore.

One or more illustrative embodiments incorporating the features of the present disclosure are presented herein. For the sake of clarity, not all features of a physical implementation are necessarily described or shown in this application. It is to be understood that in the development of a physical implementation incorporating the embodiments of the present disclosure, numerous implementation-specific decisions may be made to achieve the developer's goals, such as compliance with system-related, business-related, government-related and other constraints, which may vary by implementation and from time to time. While a developer's efforts might be time-consuming, such efforts would be, nevertheless, a routine undertaking for one having ordinary skill in the art and the benefit of this disclosure.

As discussed above, annular pressure buildup can be extremely problematic in some wellbores. Current solutions for mitigating annular pressure buildup can be complicated and expensive to implement. In addition, some current solutions for mitigating annular pressure buildup only provide thermal expansion protection over a single thermal cycle.

In response to the difficulties posed by conventional techniques for mitigating annular pressure buildup, the present inventors discovered that various materials having a negative coefficient of thermal expansion (CTE) may be used as a pressure-mitigating material within a wellbore. Such materials will be referred to herein as “negative CTE materials.” As used herein, the term “negative coefficient of thermal expansion” will refer to a coefficient of thermal expansion (a) whose value is less than zero. As one of ordinary skill in the art will recognize, a negative CTE material will decrease in volume as it is heated, thereby decreasing the effective pressure exerted by the material. Specifically, the present inventors recognized that by incorporating sufficient quantities of a negative CTE material within the sealed annular space of a wellbore, a volume decrease in the negative CTE material may at least partially offset the pressure increase produced by other materials in the annular space having a positive CTE. As discussed below, the negative CTE material and the amount to be included within the annular space can be chosen based upon the conditions present within the annular space and the anticipated baseline pressure rise.

Negative CTE materials can provide a number of significant advantages over existing techniques for mitigating annular pressure buildup. Foremost, thermal expansion and contraction are reversible processes. Thus, negative CTE materials can accommodate volume changes that occur over multiple cycles of heating and cooling.

Although they are considerably less common than are positive CTE materials (α>0), many types of negative CTE materials are now known. The negative CTE values can span a considerable magnitude range in these materials. Further, the negative CTE value can vary as a function of temperature, and there may be only certain temperature ranges where the CTE displays a negative value, thereby influencing the extent of volume reduction that the negative CTE material is capable of producing in a given temperature range. The present inventors recognized that this variance may be taken into account in judiciously selecting a particular negative CTE material for the intrinsic thermal conditions that are present in a given annular space within a wellbore. The amount of the negative CTE material to be introduced into the annular space can also be determined based upon the negative CTE value and the anticipated pressure rise to be mitigated. Advantageously, several negative CTE materials display negative CTE values over the temperature ranges commonly found in a downhole environment. The magnitude of the negative CTE value and the loading of the negative CTE material in the annular space may also need to be taken into account based upon the needed degree of volume reduction within the annular space.

The present inventors further recognized that a number of negative CTE materials are compatible with the types of chemical environments that are often present within a wellbore. Hence, a particular negative CTE material may be selected based on its chemical properties in order to achieve chemical compatibility with known downhole conditions. In addition, the base structure of a number of negative CTE materials may be chemically modified during synthesis or afterward in order to further tailor the magnitude of the negative CTE value and/or the operable temperature range. Mixtures of negative CTE materials may also be used to tailor the effective volume reduction response. Hence, the techniques described herein offer considerable operational flexibility based upon one's proper selection of the negative CTE material.

A further advantage recognized by the present inventors is that negative CTE materials may be introduced directly into an annular space within a wellbore without replacing an existing fluid therein. For example, by including a negative CTE material in a drilling fluid while drilling a wellbore, the drilling fluid and the negative CTE material can become sealed in the annular space once a subsequent casing pipe is placed in the wellbore and cemented in place.

In other implementations, a treatment fluid containing a negative CTE material may be used to at least partially displace an existing fluid from the annular space before sealing of the annular space takes place. For example, a spacer fluid or a displacement fluid may at least partially displace an existing fluid from the annular space before cementing seals an entry to the annulus. The present inventors advantageously recognized that displacement of an existing fluid from the annular space need not necessarily be complete in order for the negative CTE material to provide its pressure-mitigating benefits. Specifically, even partial replacement of an existing annular fluid with a treatment fluid containing a negative CTE material may be sufficient to offset the effects of a positive CTE material during heating. The partial replacement of an existing annular fluid with a treatment fluid containing a negative CTE material represents a “law of mixtures” effect with respect to the negative CTE material. That is, even partial replacement of an existing annular fluid with a negative CTE material may be sufficient to overcome volume expansion during heating within the annular space. Partial replacement of the existing annular fluid advantageously avoids having to recirculate all of the existing annular fluid back to the wellbore. This is a more cost effective solution than placing the negative CTE material in the entirety of a drilling fluid. Again, the negative CTE material and the extent of replacement may be selected in order to achieve a desired degree of effective volume reduction.

Finally, the present inventors also recognized that the foregoing benefits of a negative CTE material may also be realized when the negative CTE material is disposed on a surface within the annular space. For example, even when a negative CTE material is coated on a casing surface, the negative CTE material may still decrease in volume upon heating and mitigate the effects of annular pressure buildup. By promoting deposition of a negative CTE material upon a casing surface, potential issues associated with unwanted modification of a treatment fluid's properties by the negative CTE material may be averted. Alternatively, a negative CTE material may be pre-coated onto a casing pipe before it is placed downhole, thereby further simplifying the issues associated with delivering the negative CTE material for mitigating annular pressure buildup.

In various embodiments, methods for mitigating annular pressure buildup may comprise providing a wellbore containing an annular space having one or more annuli therein; selecting a pressure-mitigating material based upon one or more conditions present within the annular space, the pressure-mitigating material having a negative coefficient of thermal expansion; introducing the pressure-mitigating material into the annular space of the wellbore; sealing at least a portion of the annular space after introducing the pressure-mitigating material thereto; and subjecting the pressure-mitigating material to a temperature increase in the sealed portion of the annular space to decrease a volume occupied therein by the pressure-mitigating material.

In various embodiments, one or more of the sealed annuli are not accessible from the upper terminus of the wellbore. As discussed hereinabove, this condition can make it difficult to bleed off pressure from within the annuli. This condition may particularly be prevalent in a subsea wellbore. As used herein, the term “subsea wellbore” will refer to any wellbore whose upper terminus is located in a subterranean formation below a body of water of any type.

In some embodiments, the pressure-mitigating material may be introduced to the wellbore in a treatment fluid. Treatment fluids can be used in a variety of subterranean operations. Such subterranean operations can include, without limitation, drilling operations, stimulation operations, production operations, remediation operations, sand control treatments and the like. As used herein, the terms “treat,” “treatment,” “treating” and related variants thereof refer to any subterranean operation that uses a fluid in conjunction with achieving a desired function and/or for a desired purpose. Use of these terms does not imply any particular action by the treatment fluid or any component thereof, unless otherwise specified herein. Illustrative treatment operations can include, for example, drilling operations, fracturing operations, gravel packing operations, acidizing operations, scale dissolution and removal operations, consolidation operations, and the like.

Treatment fluids of the present disclosure comprise a carrier fluid in which the pressure-mitigating material is disposed. Suitable carrier fluids may include, for example, an aqueous carrier fluid. Suitable aqueous carrier fluids may include, for example, fresh water, saltwater (e.g., water containing one or more salts dissolved therein), brine (e.g., saturated salt water), seawater, or any combination thereof. Other aqueous carrier fluids are also possible, and generally, the aqueous carrier fluid may be obtained from any source that does not provide components that adversely affect a treatment operation being conducted in the subterranean environment. One having ordinary skill in the art and the benefit of the present disclosure will be able to choose a suitable aqueous carrier fluid and the amount thereof. For example, in some embodiments, an aqueous-miscible organic solvent may be present as a co-solvent in an aqueous carrier fluid.

Similarly, in other embodiments, a non-aqueous carrier fluid, such as a hydrocarbon-based carrier fluid, may be used to introduce the pressure-mitigating material to the wellbore. Again, the choice of a suitable non-aqueous carrier fluid and the amount thereof may be made by one having ordinary skill in the art and the benefit of the present disclosure.

In some embodiments, the pressure-mitigating material may be introduced into the annular space in a drilling fluid while drilling the wellbore. That is, in some embodiments, the methods of the present disclosure may comprise drilling a wellbore using a drilling fluid comprising a pressure-mitigating material. Once a subsequent casing pipe is introduced into the wellbore, the drilling fluid may fill the created annulus, thereby directly placing the pressure-mitigating material in the proper location to mitigate thermal expansion once sealing of the annulus takes place. Directly incorporating the pressure-mitigating material within the annular space during the drilling stage can advantageously avoid having to replace the annular fluid during a separate fluid exchange operation.

In alternative embodiments, the pressure-mitigating material may be introduced to the annular space in a spacer fluid or a displacement fluid. Such treatment fluids may replace at least a portion of the drilling fluid in the annular space with a carrier fluid containing the pressure-mitigating material. In some embodiments, the replaced drilling fluid may lack a pressure-mitigating material. For example, if the pressure-mitigating material adversely affects the rheological properties of the drilling fluid, it may be more effective to introduce the pressure-mitigating material to the annular space separately from the drilling fluid. In other embodiments, the replaced drilling fluid may contain a different amount of a pressure-mitigating material and/or a different pressure-mitigating material than was present in the spacer fluid or the displacement fluid. The latter embodiments may be used, for example, when it is determined that different pressure-mitigating capabilities are needed after initiating drilling of a particular wellbore segment.

When introduced into the annular space in a carrier fluid, the pressure-mitigating material may be dispersed in the carrier fluid as a plurality of particulates. Once introduced into the annular space and sealed within the one or more annuli, the volume occupied by the particulates can decrease upon heating, thereby decreasing the pressure buildup that occurs within the annular space. The size and shape of the particulates is not believed to be particularly limited in the embodiments described herein, and the size and shape may be dictated by the particular negative CTE material used. In some embodiments, the particulates of the pressure-mitigating material may be in the form of nanoparticles. The particulates of the pressure-mitigating material may remain dispersed within the carrier fluid when in the annular space, or they may become coated upon at least one surface within the annular space once sealed therein. That is, in some embodiments, the methods described herein may further comprise coating at least a portion of the pressure-mitigating material onto at least one surface within the annular space.

In more specific embodiments, the pressure-mitigating material may be coated on at least one casing surface within the wellbore. Even when present in the form of a coating, the pressure-mitigating material can continue to be effective in alleviating the effects of annular pressure buildup. In some embodiments, a treatment fluid containing the pressure-mitigating material may be formulated to deposit such a coating on the casing surface in situ within the wellbore. In other embodiments, the pressure-mitigating material may be pre-coated onto a casing surface before disposing the casing in the wellbore. The casing defines at least a portion of the annular space once introduced into the wellbore. The approach of pre-coating the pressure-mitigating material onto the casing surface again obviates the need for replacing the annular fluid with a fluid phase containing the pressure-mitigating material.

Depending on the conditions that are present within the wellbore and its annular space, the pressure-mitigating material and the amount thereof may be selected to provide a desired degree of volume contraction upon being heated within the annular space. A suitable pressure-mitigating material may be selected, for example, based upon the temperature that is present in the particular annulus where it is to be introduced. That is, in some embodiments, the one or more conditions present within the annular space comprises at least the temperature within the annular space. Another factor to consider is the temperature of a treatment fluid prior to its introduction to the subterranean formation, which determines the temperature differential and possible extent of volume expansion or contraction. Further, as indicated above, a suitable pressure-mitigating material may be chosen such that in the temperature range of the annular space, the CTE of the pressure-mitigating material is indeed negative and has a sufficient magnitude to accomplish a desired degree of volume reduction when present in a sufficient quantity. Similarly, based on the needed degree of volume reduction within the annular space, an amount of the pressure-mitigating material to be incorporated therein may be chosen in conjunction with the expected temperature differential. In further embodiments, a suitable pressure-mitigating material may be chosen based upon the chemical conditions that are present within the wellbore. For example, a suitable pressure-mitigating material may be chosen to maintain chemical compatibility with the conditions present in the downhole environment.

The methods described herein also offer the opportunity, if desired, to introduce different pressure-mitigating materials into one or more of the annuli within the annular space. Similarly, the methods described herein also offer the opportunity, if desired, to place different amounts of the pressure-mitigating materials in one or more of the annuli within the annular space. Placing different pressure-mitigating materials and/or amounts thereof in a given annulus can allow further tailoring of the present methods to be realized by better addressing the temperature conditions present in a particular annulus. For example, an inner annulus in proximity to hot wellbore fluids may be subject to a greater temperature rise than is an outer annulus nearer the walls of the subterranean formation. Accordingly, in some embodiments, at least one of the annuli in the annular space may contain a different pressure-mitigating material than is present in the other annuli and/or an amount thereof. In other embodiments, the same pressure-mitigating material and amounts thereof may be present in each annulus.

In some embodiments of the present disclosure, a pressure-mitigating material having a negative coefficient of thermal expansion may be combined with a material having a positive coefficient of thermal expansion to produce a composite material having an overall negative coefficient of thermal expansion. Assuming that no chemical reaction takes place between a negative CTE material and a positive CTE material, a “law of mixtures” calculation may be used to determine whether a composite material will have an overall positive or negative CTE value. There may be a number of reasons for combining a negative CTE material with a positive CTE material. For example, a positive CTE material may serve as a suitable carrier or support for the negative CTE material. A positive CTE material might be used as a carrier or support, for example, if the negative CTE material is overly expensive, hygroscopic, water-soluble, or lacks sufficient mechanical strength for being conveyed into a wellbore. A carrier fluid used for introducing the pressure-mitigating material into a subterranean formation may likewise have a positive CTE.

A number of pressure-mitigating materials having a negative coefficient of thermal expansion value may be suitable for use in the methods described herein. Several classes of illustrative negative CTE materials are described hereinafter. As indicated above, one having ordinary skill in the art will be able to choose a particular pressure-mitigating material for use in a specific situation given the benefit of the present disclosure. Pressure-mitigating materials suitable for use in the embodiments described herein may display isotropic or anisotropic volume contraction when exposed to a temperature increase.

In some embodiments, a suitable pressure-mitigating material may have a formula of A(MO₄)₂, wherein A is zirconium or hafnium, and M is tungsten or molybdenum.

In some embodiments, a suitable pressure-mitigating material may have a formula of AP₂O₇, wherein A is a tetravalent metal ion. Suitable tetravalent metal ions can include thorium, uranium, cerium, hafnium, zirconium, titanium, molybdenum, platinum, lead, tin, germanium and silicon.

In some embodiments, a suitable pressure-mitigating material may have a formula of A₂(MO₄)₃, wherein A is scandium, yttrium, lutetium, aluminum or another trivalent metal ion, and M is tungsten or molybdenum.

In some embodiments, a suitable pressure-mitigating material may include compounds having a formula of ZrV₂O₇, Zr₂P₂WO₁₂, Zr₂P₂MoO₁₂, NaZr₂P₃O₁₂ or Ca₁₋ₓMₓZr₄P₆O₂₄, wherein M is strontium, barium or magnesium and x is a real number ranging between 0 and 1.

In some embodiments, a suitable pressure-mitigating material may include metal-cyano compounds having a formula of M(CN)₂, wherein M is cadmium or zinc. Other metal-cyano compounds similarly having a negative coefficient of thermal expansion include, for example, Zn₃[Fe(CN)₆]₂, Fe₃[Zn(CN)₆]₂, Co₃[Co(CN)₆]₂, and Mn₃[Co(CN)₆]₂.

In some embodiments, a nanocrystalline material may comprise the pressure-mitigating material. Suitable nanocrystalline materials with a negative coefficient of thermal expansion may include, for example, nanocrystalline copper (II) oxide or nanocrystalline manganese fluoride.

In some embodiments, a suitable pressure-mitigating material may comprise LaFe₁₃₋ₓSiₓ, wherein x is a real number less than 13 and above 0, typically ranging between about 1.5 and about 2.4. In related embodiments, a suitable pressure-mitigating material may comprise LaFe_{11.5-x}CoₓSi_{1.5}, wherein x is a real number less than 11.5 and above 0, typically ranging between about 0.2 to 1.0. For at least these materials, the choice of x may allow the magnitude of the negative coefficient of thermal expansion and the temperature region where the coefficient of thermal expansion is negative to be adjusted. Other materials may be modified similarly during their chemical synthesis by including non-stoichiometric amounts of metal or non-metal ions into their base chemical formula, or chemical modifications may take place following synthesis in some embodiments. Accordingly, in at least some embodiments, selecting the pressure-mitigating material may further comprise modifying a chemical composition of the pressure-mitigating material to accommodate the one or more conditions present within the annular space of the wellbore.

Accordingly, in more specific embodiments, suitable pressure-mitigating materials for use in mitigating annular pressure buildup may be selected from the group consisting of ZrW₂O₈, LaFe₁₃₋ₓSiₓ (x=a real number ranging between about 1.5 and about 2.4), LaFe_{11.5-x}CoₓSi_{1.5} (x=a real number ranging between about 0.2 and about 1.0), Mn₃(Cu₁₋ₓGeₓ)N (x=a real number ranging between about 0.4 and about 0.55), Ag₃[Co(CN)₆], Zn(CN)₂, nanocrystalline CuO, nanocrystalline MnF₂, and any combination thereof.

In some embodiments, the pressure-mitigating material may be selected to have a negative coefficient of thermal expansion value over a temperature range of about 50° F. to about 400° F. In more specific embodiments, the temperature at which the CTE value is negative may range between about 100° F. and about 300° F. In various embodiments, the negative CTE value may range between about −5×10⁻⁶/° C. and about −400×10⁻⁶/° C. In more particular embodiments, the negative CTE value may range between about −5×10⁻⁶/° C. and about −50×10⁻⁶/° C.

In some embodiments, the amount of negative CTE material can be chosen to produce a desired degree of volume contraction within the annular space. In some embodiments, an amount of the negative CTE material may be chosen to produce about 75% or less of the pressure increase than if the negative CTE material was not present. Higher levels of pressure increase mitigation can be produced by increasing the amount of the negative CTE material.

In more particular embodiments, methods for mitigating annular pressure buildup may comprise: introducing a spacer fluid or a displacement fluid into a wellbore comprising an annular space having one or more annuli therein, the spacer fluid or the displacement fluid comprising a pressure-mitigating material having a negative coefficient of thermal expansion; at least partially filling the annular space of the wellbore with the spacer fluid or the displacement fluid; sealing at least a portion of the annular space after filling the portion of the annular space with the spacer fluid or the displacement fluid; and subjecting the pressure-mitigating material to a temperature increase in the sealed portion of the annular space to decrease a volume occupied therein by the pressure-mitigating material; wherein the pressure-mitigating material and an amount thereof are selected based upon one or more conditions present within the annular space.

In other particular embodiments, methods for mitigating annular pressure buildup by introducing a negative CTE material during the drilling phase are described herein. In more specific embodiments, the methods may comprise: drilling a wellbore using a drilling fluid comprising a carrier fluid and a pressure-mitigating material, the pressure-mitigating material having a negative coefficient of thermal expansion; at least partially filling an annular space of the wellbore with the drilling fluid, the annular space having one or more annuli therein; sealing at least a portion of the annular space after filling the portion of the annular space with the drilling fluid; and increasing a temperature of the drilling fluid within the sealed portion of the annular space to decrease a volume occupied therein by the pressure-mitigating material.

In some embodiments, the methods described herein for mitigating annular pressure buildup may be used in combination with one another and/or with other techniques used for mitigating annular pressure buildup. Accordingly, in some embodiments, a pressure-mitigating material comprising a negative CTE material may be used in combination with a pressure-collapsible material, such as hollow spheres and syntactic foam. The use of the pressure-mitigating techniques in combination with one another may be complementary, for example, with the negative CTE material providing initial volume mitigation, and the pressure-collapsible material becoming operative at higher pressures. Use of a negative CTE material in combination with a pressure-collapsible material may allow a greater degree of volume change within the annular space to be tolerated.

In still other embodiments, the negative CTE material may be formulated in a hollow sphere form or a syntactic foam form. In such embodiments, the negative CTE material may function by thermally contracting at low annular pressure levels. Above a threshold collapse pressure for the hollow sphere or syntactic foam, the negative CTE material may further accommodate an annular pressure increase by collapsing to decrease its volume. Even after its collapse in such embodiments, the negative CTE material may continue mitigating annular pressure buildup in the manner described herein.

In other various embodiments, systems configured for delivering a pressure-mitigating material to a downhole location are described. In various embodiments, the systems can comprise a pump fluidly coupled to a tubular, the tubular containing a treatment fluid comprising a pressure-mitigating material. The pressure-mitigating material comprises a negative coefficient of thermal expansion material.

The pump may be a high pressure pump in some embodiments. As used herein, the term “high pressure pump” will refer to a pump that is capable of delivering a fluid downhole at a pressure of about 1000 psi or greater. A high pressure pump may be used when it is desired to introduce a treatment fluid of the present disclosure to a subterranean formation at or above a fracture gradient of the subterranean formation, but it may also be used in cases where fracturing is not desired. The treatment fluids described herein may be introduced with a high pressure pump, or they may be introduced following a treatment fluid that was introduced with a high pressure pump. In some embodiments, the high pressure pump may be capable of fluidly conveying particulate matter into the subterranean formation. Suitable high pressure pumps will be known to one having ordinary skill in the art and may include, but are not limited to, floating piston pumps and positive displacement pumps.

In other embodiments, the pump may be a low pressure pump. As used herein, the term “low pressure pump” will refer to a pump that operates at a pressure of about 1000 psi or less. In some embodiments, a low pressure pump may be fluidly coupled to a high pressure pump that is fluidly coupled to the tubular. That is, in such embodiments, the low pressure pump may be configured to convey the treatment fluid to the high pressure pump. In such embodiments, the low pressure pump may “step up” the pressure of a treatment fluid before it reaches the high pressure pump. Alternately, the low pressure pump may be used to directly introduce the treatment fluid to the subterranean formation.

In some embodiments, the systems described herein can further comprise a mixing tank that is upstream of the pump and in which the pressure-mitigating material is formulated with a carrier fluid. In various embodiments, the pump (e.g., a low pressure pump, a high pressure pump, or a combination thereof) may convey the treatment fluid from the mixing tank or other source of the treatment fluid to the tubular. In other embodiments, however, the treatment fluid can be formulated offsite and transported to a worksite, in which case the treatment fluid may be introduced to the tubular via the pump directly from its shipping container (e.g., a truck, a railcar, a barge, or the like) or from a transport pipeline. In either case, the treatment fluid may be drawn into the pump, elevated to an appropriate pressure, and then introduced into the tubular for delivery downhole.

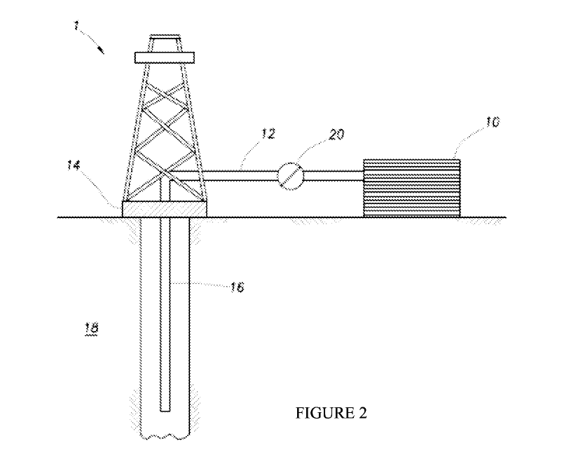

FIG. 2 shows an illustrative schematic of a system that can deliver treatment fluids of the present disclosure to a downhole location, according to one or more embodiments. It should be noted that while FIG. 2 generally depicts a land-based system, it is to be recognized that like systems may be operated in subsea locations as well. As depicted in FIG. 2, system 8 may include mixing tank 10, in which a treatment fluid of the present disclosure may be formulated. The treatment fluid may be conveyed via line 12 to wellhead 14, where the treatment fluid enters tubular 16, tubular 16 extending from wellhead 14 into subterranean formation 18. In the interest of clarity, the multi-annular nature of the wellbore is not shown in FIG. 2. Tubular 16 may include orifices that allow the treatment fluid to enter into the wellbore. Pump 20 may be configured to raise the pressure of the treatment fluid to a desired degree before its introduction into tubular 16. It is to be recognized that system 8 is merely exemplary in nature and various additional components may be present that have not necessarily been depicted in FIG. 2 in the interest of clarity. Non-limiting additional components that may be present include, but are not limited to, supply hoppers, valves, condensors, adapters, joints, gauges, sensors, compressors, pressure controllers, pressure sensors, flow rate controllers, flow rate sensors, temperature sensors, and the like.

Although not depicted in FIG. 2, the treatment fluid may, in some embodiments, flow back to wellhead 14 and exit subterranean formation 18. In some embodiments, the treatment fluid that has flowed back to wellhead 14 may subsequently be recovered and recirculated to subterranean formation 18. In other embodiments, the treatment fluid may flow back to wellhead 14 in a produced hydrocarbon fluid from the subterranean formation.

It is also to be recognized that the disclosed treatment fluids may also directly or indirectly affect the various downhole equipment and tools that may come into contact with the treatment fluids during operation. Such equipment and tools may include, but are not limited to, wellbore casing, wellbore liner, completion string, insert strings, drill string, coiled tubing, slickline, wireline, drill pipe, drill collars, mud motors, downhole motors and/or pumps, surface-mounted motors and/or pumps, centralizers, turbolizers, scratchers, floats (e.g., shoes, collars, valves, etc.), logging tools and related telemetry equipment, actuators (e.g., electromechanical devices, hydromechanical devices, etc.), sliding sleeves, production sleeves, plugs, screens, filters, flow control devices (e.g., inflow control devices, autonomous inflow control devices, outflow control devices, etc.), couplings (e.g., electro-hydraulic wet connect, dry connect, inductive coupler, etc.), control lines (e.g., electrical, fiber optic, hydraulic, etc.), surveillance lines, drill bits and reamers, sensors or distributed sensors, downhole heat exchangers, valves and corresponding actuation devices, tool seals, packers, cement plugs, bridge plugs, and other wellbore isolation devices, or components, and the like. Any of these components may be included in the systems generally described above and depicted in FIG. 2.

Embodiments disclosed herein include:

A. Methods for mitigating annular pressure buildup. The methods comprise: providing a wellbore containing an annular space having one or more annuli therein; selecting a pressure-mitigating material based upon one or more conditions present within the annular space, the pressure-mitigating material having a negative coefficient of thermal expansion; introducing the pressure-mitigating material into the annular space of the wellbore; sealing at least a portion of the annular space after introducing the pressure-mitigating material thereto; and subjecting the pressure-mitigating material to a temperature increase in the sealed portion of the annular space to decrease a volume occupied therein by the pressure-mitigating material.

B. Methods for mitigating annular pressure buildup. The methods comprise: introducing a spacer fluid or a displacement fluid into a wellbore comprising an annular space having one or more annuli therein, the spacer fluid or the displacement fluid comprising a pressure-mitigating material having a negative coefficient of thermal expansion; at least partially filling the annular space of the wellbore with the spacer fluid or the displacement fluid; sealing at least a portion of the annular space after filling the portion of the annular space with the spacer fluid or the displacement fluid; and subjecting the pressure-mitigating material to a temperature increase in the sealed portion of the annular space to decrease a volume occupied therein by the pressure-mitigating material; wherein the pressure-mitigating material and an amount thereof are selected based upon one or more conditions present within the annular space.

C. Methods for mitigating annular pressure buildup. The methods comprise: drilling a wellbore using a drilling fluid comprising a carrier fluid and a pressure-mitigating material, the pressure-mitigating material having a negative coefficient of thermal expansion; at least partially filling an annular space of the wellbore with the drilling fluid, the annular space having one or more annuli therein; sealing at least a portion of the annular space after filling the portion of the annular space with the drilling fluid; and increasing a temperature of the drilling fluid within the sealed portion of the annular space to decrease a volume occupied therein by the pressure-mitigating material.

D. Systems for mitigating annular pressure buildup. The systems comprise: a pump fluidly coupled to a tubular, the tubular containing a treatment fluid comprising a pressure-mitigating material, the pressure-mitigating material comprising a negative coefficient of thermal expansion (CTE) material.

Each of embodiments A-D may have one or more of the following additional elements in any combination:

Element 1: wherein the pressure-mitigating material is introduced into the annular space in a drilling fluid while drilling the wellbore.

Element 2: wherein the pressure-mitigating material is introduced into the annular space in a spacer fluid or a displacement fluid.

Element 3: wherein the wellbore comprises a subsea wellbore.

Element 4: wherein the pressure-mitigating material comprises a substance selected from the group consisting of ZrW₂O₈, LaFe₁₃₋ₓSiₓ (x=a real number ranging between about 1.5 and about 2.4), LaFe_{11.5-x}CoₓSi_{1.5} (x=a real number ranging between about 0.2 to 1.0), Mn₃(Cu₁₋ₓGeₓ)N (x=a real number ranging between 0.4 and 0.55), Ag₃[Co(CN)₆], Zn(CN)₂, nanocrystalline CuO, nanocrystalline MnF₂, and any combination thereof.

Element 5: wherein selecting the pressure-mitigating material further comprises modifying a chemical composition of the pressure-mitigating material to accommodate the one or more conditions present within the annular space.

Element 6: wherein the one or more conditions present within the annular space comprises at least the temperature within the annular space.

Element 7: wherein the pressure-mitigating material comprises a plurality of particulates that are introduced into the annular space in a carrier fluid.

Element 8: wherein the method further comprises coating at least a portion of the pressure-mitigating material onto at least one surface within the annular space.

Element 9: wherein the pressure-mitigating material is pre-coated onto a casing surface before disposing the casing in the wellbore, the casing defining at least a portion of the annular space once introduced into the wellbore.

Element 10: wherein the method further comprises selecting an amount of the pressure-mitigating material to introduce into the annular space of the wellbore based upon the one or more conditions present within the annular space.

Element 11: wherein the pressure-mitigating material comprises a plurality of particulates that are dispersed in the spacer fluid or the displacement fluid within the annular space.

By way of non-limiting example, exemplary combinations applicable to A-D include:

The method of A in combination with elements 1 and 4.

The method of A in combination with elements 2 and 4.

The method of A in combination with elements 1 and 3.

The method of A in combination with elements 4 and 7.

The method of B in combination with elements 4 and 10.

The method of B in combination with elements 4 and 8.

The method of B in combination with elements 3 and 11.

The method of B in combination with elements 3, 4 and 11.

The method of C in combination with elements 3 and 4.

The method of C in combination with elements 4 and 6.

The method of C in combination with elements 4 and 8.

The method of C in combination with elements 8 and 10.

The system of D in combination with elements 3 and 4.

To facilitate a better understanding of the embodiments of the present disclosure, the following examples of preferred or representative embodiments are given. In no way should the following examples be read to limit, or to define, the scope of the disclosure.

### EXAMPLES

### Example 1

### Calculated Amounts of Various Pressure-Mitigating Materials to Produce a Given Volume Decrease

In order for a pressure-mitigating material to be effective in addressing annular pressure buildup, it must limit the pressure increase within the annular space to an acceptable degree. Once an acceptable amount of volume change within the annular space is established, the requisite volume fraction of the pressure-mitigating material can be calculated. The calculated volume fraction of the pressure-mitigating material is based upon at least temperature within the annular space and the pressure-mitigating material's CTE.

In this example, the heating of water from an initial temperature and pressure of 20° C. and 2500 psia to 90° C. was calculated to produce a pressure increase of 12000 psi. This represents a control value. The calculations of this example assume isotropic expansion and isochoric conditions for the remainder of the components of the annular space. In practice, thermal expansion of the tubing and casing can somewhat attenuate the maximum pressure observed through volume expansion of the annular fluid alone.

The volume fraction of various pressure-mitigating materials needed to limit the pressure increase to 25%, 50% and 75% of the control value was then determined. The pressure-mitigating materials and their average CTE values are shown in Table 1. For Mn₃Cu_{0.5}Ge_{0.5}N and LaFe_{10.5}CoSi_{1.5}, the CTE values are average values over the temperature range 20° C. to 90° C.

TABLE 1

| Pressure-Mitigating Material | CTE (C⁻¹) |
|---|---|
| ZrW₂O₈ | −8.7 × 10⁻⁶ |
| Mn₃Cu_{0.5}Ge_{0.5}N | −9.2 × 10⁻⁶ |
| LaFe_{10.5}CoSi_{1.5} | −29.6 × 10⁻⁶ |

Table 2 summarizes the volume fraction of each pressure-mitigating material needed to achieve a particular level of pressure reduction.

TABLE 2

| Pressure | | | |
|---|---|---|---|
| Increase | Volume Fraction of Pressure-Mitigating Material | | |
| (% of Control) | ZrW₂O₈ | Mn₃Cu_{0.5}Ge_{0.5}N | LaFe_{10.5}CoSi_{1.5} |
| 25 | 0.931 | 0.927 | 0.798 |
| 50 | 0.897 | 0.891 | 0.719 |
| 75 | 0.808 | 0.800 | 0.553 |

As can be seen from Table 2, LaFe_{10.5}CoSi_{1.5}, due to its significantly higher magnitude CTE, was operative to affect a given pressure increase at a lower volume fraction compared to the other materials.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the specification and attached claims are approximations that may vary depending upon the desired properties sought to be obtained by the embodiments of the present disclosure. At the very least, and not as an attempt to limit the application of the doctrine of equivalents to the scope of the claim, each numerical parameter should at least be construed in light of the number of reported significant digits and by applying ordinary rounding techniques.

Therefore, the present disclosure is well adapted to attain the ends and advantages mentioned as well as those that are inherent therein. The particular embodiments disclosed above are illustrative only, as the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present disclosure. The disclosure illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A method comprising:
providing a wellbore containing an annular space having one or more annuli therein;
selecting a pressure-mitigating material based upon one or more conditions present within the annular space, the pressure-mitigating material having a negative coefficient of thermal expansion;
introducing the pressure-mitigating material into the annular space of the wellbore;
sealing at least a portion of the annular space after introducing the pressure-mitigating material thereto; and
subjecting the pressure-mitigating material to a temperature increase in the sealed portion of the annular space to decrease a volume occupied therein by the pressure-mitigating material.

2. The method of claim 1, wherein the pressure-mitigating material is introduced into the annular space in a drilling fluid while drilling the wellbore.

3. The method of claim 1, wherein the pressure-mitigating material is introduced into the annular space in a spacer fluid or a displacement fluid.

4. The method of claim 1, wherein the wellbore comprises a subsea wellbore.

5. The method of claim 1, wherein the pressure-mitigating material comprises a substance selected from the group consisting of ZrW₂O₈, LaFe₁₃₋ₓSiₓ (x=a real number ranging between about 1.5 and about 2.4), LaFe_{11.5-x}CoₓSi_{1.5} (x=a real number ranging between about 0.2 to 1.0), Mn₃(Cu₁₋ₓGeₓ)N (x=a real number ranging between 0.4 and 0.55), Ag₃[Co(CN)₆], Zn(CN)₂, nanocrystalline CuO, nanocrystalline MnF₂, and any combination thereof.

6. The method of claim 1, wherein selecting the pressure-mitigating material further comprises modifying a chemical composition of the pressure-mitigating material to accommodate the one or more conditions present within the annular space.

7. The method of claim 1, wherein the one or more conditions present within the annular space comprises at least the temperature within the annular space.

8. The method of claim 1, wherein the pressure-mitigating material comprises a plurality of particulates that are introduced into the annular space in a carrier fluid.

9. The method of claim 1, further comprising:
coating at least a portion of the pressure-mitigating material onto at least one surface within the annular space.

10. The method of claim 9, wherein the pressure-mitigating material is pre-coated onto a casing surface before disposing the casing in the wellbore, the casing defining at least a portion of the annular space once introduced into the wellbore.

11. The method of claim 1, further comprising:
selecting an amount of the pressure-mitigating material to introduce into the annular space of the wellbore based upon the one or more conditions present within the annular space.

12. A method comprising:
introducing a spacer fluid or a displacement fluid into a wellbore comprising an annular space having one or more annuli therein, the spacer fluid or the displacement fluid comprising a pressure-mitigating material having a negative coefficient of thermal expansion;
at least partially filling the annular space of the wellbore with the spacer fluid or the displacement fluid;
sealing at least a portion of the annular space after filling the portion of the annular space with the spacer fluid or the displacement fluid; and
subjecting the pressure-mitigating material to a temperature increase in the sealed portion of the annular space to decrease a volume occupied therein by the pressure-mitigating material;
the pressure-mitigating material and an amount thereof are selected based upon one or more conditions present within the annular space.

13. The method of claim 12, wherein the pressure-mitigating material comprises a plurality of particulates that are dispersed in the spacer fluid or the displacement fluid within the annular space.

14. The method of claim 12, further comprising:
coating at least a portion of the pressure-mitigating material onto at least one surface within the annular space.

15. The method of claim 12, wherein the wellbore comprises a subsea wellbore.

16. The method of claim 12, wherein the pressure-mitigating material comprises a substance selected from the group consisting of ZrW₂O₈, LaFe₁₃₋ₓSiₓ (x=a real number ranging between about 1.5 and about 2.4), LaFe_{11.5-x}CoₓSi_{1.5} (x=a real number ranging between about 0.2 to 1.0), Mn₃(Cu₁₋ₓGeₓ)N (x=a real number ranging between 0.4 and 0.55), Ag₃[Co(CN)₆], Zn(CN)₂, nanocrystalline CuO, nanocrystalline MnF₂, and any combination thereof.

17. A method comprising:
drilling a wellbore using a drilling fluid comprising a carrier fluid and a pressure-mitigating material, the pressure-mitigating material having a negative coefficient of thermal expansion;
at least partially filling an annular space of the wellbore with the drilling fluid, the annular space having one or more annuli therein;
sealing at least a portion of the annular space after filling the portion of the annular space with the drilling fluid; and
increasing a temperature of the drilling fluid within the sealed portion of the annular space to decrease a volume occupied therein by the pressure-mitigating material.

18. The method of claim 17, wherein the wellbore comprises a subsea wellbore.

19. The method of claim 17, wherein the pressure-mitigating material comprises a substance selected from the group consisting of ZrW₂O₈, LaFe₁₃₋ₓSiₓ (x=a real number ranging between about 1.5 and about 2.4), LaFe_{11.5-x}CoₓSi_{1.5} (x=a real number ranging between about 0.2 to 1.0), Mn₃(Cu₁₋ₓGeₓ)N (x=a real number ranging between 0.4 and 0.55), Ag₃[Co(CN)₆], Zn(CN)₂, nanocrystalline CuO, nanocrystalline MnF₂, and any combination thereof.

20. The method of claim 17, further comprising:
coating at least a portion of the pressure-mitigating material onto at least one surface within the annular space.

21. A system comprising:
a pump fluidly coupled to a tubular, the tubular containing a treatment fluid comprising a pressure-mitigating material, the pressure-mitigating material comprising a negative CTE material.
